(19) United States
(12) Patent Application Publication
(10) Pub. No.: US 2023/0336280 A1
(43) Pub. Date: Oct. 19, 2023

(54) METHOD AND APPARATUS FOR CONTENTION WINDOW ADJUSTMENT ON SIDELINK

(71) Applicant: Samsung Electronics Co., Ltd., Suwon-si (KR)

(72) Inventors: Hongbo Si, Plano, TX (US); Emad N. Farag, Flanders, NJ (US); Carmela Cozzo, San Diego, CA (US); Shiyang Leng, Allen, TX (US); Kyeongin Jeong, Allen, TX (US)

(21) Appl. No.: 18/296,293

(22) Filed: Apr. 5, 2023

Related U.S. Application Data
(60) Provisional application No. 63/331,560, filed on Apr. 15, 2022.
(60) Provisional application No. 63/336,584, filed on Apr. 29, 2022.

(51) Int. Cl. H04L 1/1822; H04L 1/1829; H04W 72/25

(52) U.S. Cl. CPC H04L 1/1822; H04L 1/1854; H04W 72/25; H04L 1/1861; H04L 1/1812

(57) ABSTRACT

Methods and apparatuses for contention window adjustment on a sidelink (SL) in a wireless communication system. A method of a user equipment (UE) includes determining whether hybrid automatic repeat request (HARQ) feedback is available after a last update of a contention window size (CW); determining a set of HARQ feedback corresponding to physical sidelink shared channels (PSSCHs) in a reference duration when the at least one HARQ feedback is determined as available; and determining a first condition based on the set of HARQ feedback. The method further includes determining to: reset the CW to a minimum allowed value when the first condition is satisfied or increase the CW to a next higher allowed value when the first condition is not. The method further includes performing a SL channel access procedure based on the CW and performing a SL transmission over a channel after successfully performing the SL channel access procedure.

### CROSS-REFERENCE TO RELATED APPLICATIONS AND CLAIM OF PRIORITY

The present application claims priority to U.S. Provisional Patent Application No. 63/331,560, filed on Apr. 15, 2022, and U.S. Provisional Patent Application No. 63/336,584, filed on Apr. 29, 2022. The contents of the above-identified patent document is incorporated herein by reference.

### TECHNICAL FIELD

The present disclosure relates generally to wireless communication systems and, more specifically, the present disclosure relates to a contention window adjustment on a sidelink (SL) in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a contention window adjustment on an SL in a wireless communication system.

In one embodiment, a user equipment (UE) in a wireless communication system is provided. The UE includes a processor configured to determine whether at least one hybrid automatic repeat request (HARQ) feedback is available after a last update of a contention window size (CW); determine a set of HARQ feedback corresponding to physical sidelink shared channels (PSSCHs) in a reference duration, when the at least one HARQ feedback is determined as available after the last update of the CW; determine a first condition based on the set of HARQ feedback; determine to: reset the CW to a minimum allowed value (CWₘᵢₙ) from a set of values, when the first condition is satisfied, or increase the CW to a next higher allowed value from the set of values, when the first condition is not satisfied; and perform a sidelink (SL) channel access procedure based on the CW. The UE further includes a transceiver operably coupled to the processor. The transceiver is configured to perform a SL transmission over a channel, after successfully performing the SL channel access procedure.

In another embodiment, a method of a UE in a wireless communication system is provided. The method includes determining whether at least one HARQ feedback is available after a last update of a CW; determining a set of HARQ feedback corresponding to PSSCHs in a reference duration, when the at least one HARQ feedback is determined as available after the last update of the CW; and determining a first condition based on the set of HARQ feedback. The method further includes determining to: reset the CW to a CWₘᵢₙ from a set of values, when the first condition is satisfied or increase the CW to a next higher allowed value from the set of values, when the first condition is not satisfied. The method further includes performing a sidelink (SL) channel access procedure based on the CW and performing a SL transmission over a channel, after successfully performing the SL channel access procedure.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to the present disclosure;

FIG. 6 illustrates an example of a resource pool in Rel-16 NR V2X according to embodiments of the present disclosure;

FIG. 7 illustrates a flowchart of UE method for contention window adjustment according to embodiments of the present disclosure; and

FIG. 8 illustrates a flowchart of UE method for RSSI measurement for SL-U according to embodiments of the present disclosure.

### DETAILED DESCRIPTION

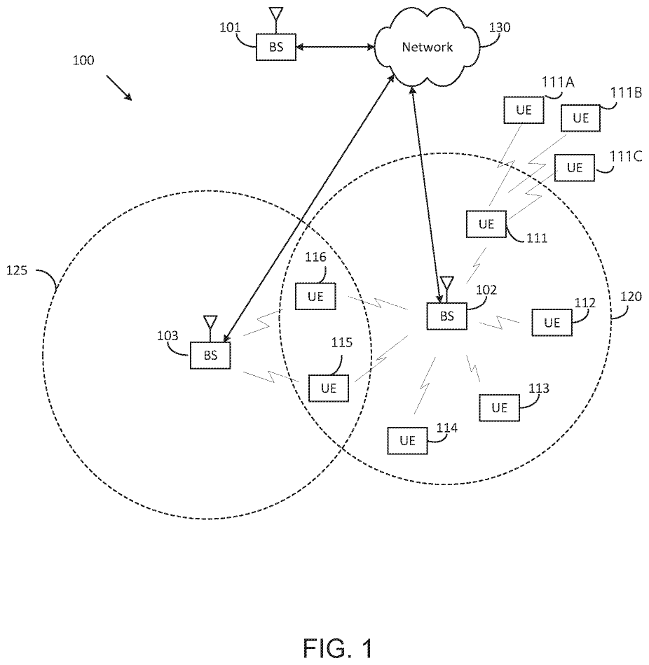

FIG. 1 through FIG. 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and Channel coding”; 3GPP TS 38.213 v16.1.0, “NR; Physical Layer Procedures for Control”; 3GPP TS 38.214 v16.1.0, “NR; Physical Layer Procedures for Data”; and 3GPP TS 38.331 v16.1.0, “NR; Radio Resource Control (RRC) Protocol Specification.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, embodiments of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UE are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a contention window adjustment on an SL in a wireless communication system. In certain embodiments, and one or more of the gNBs 101-103 includes circuitry, programing, or a combination thereof, for supporting or enabling contention window adjustment on an SL in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

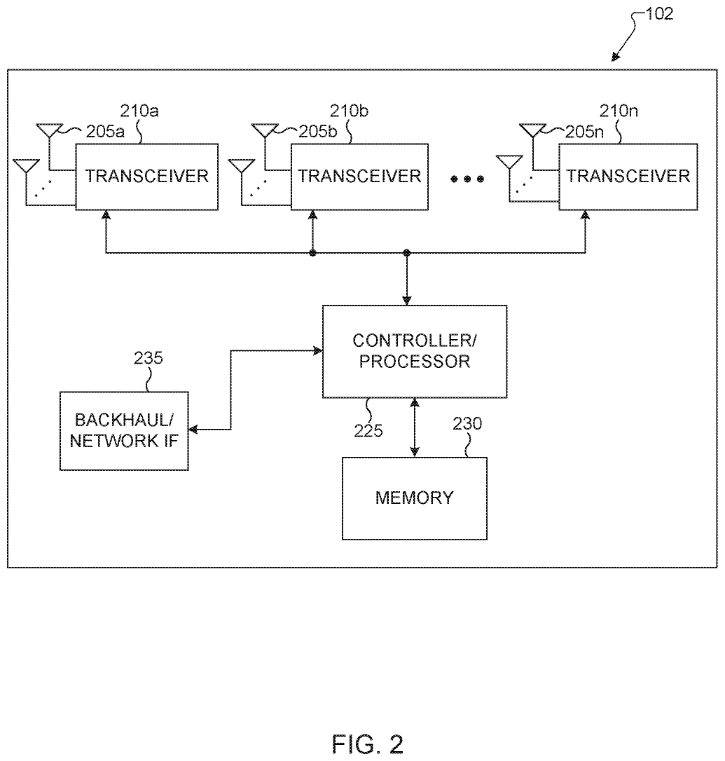

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes for a contention window adjustment on an SL in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

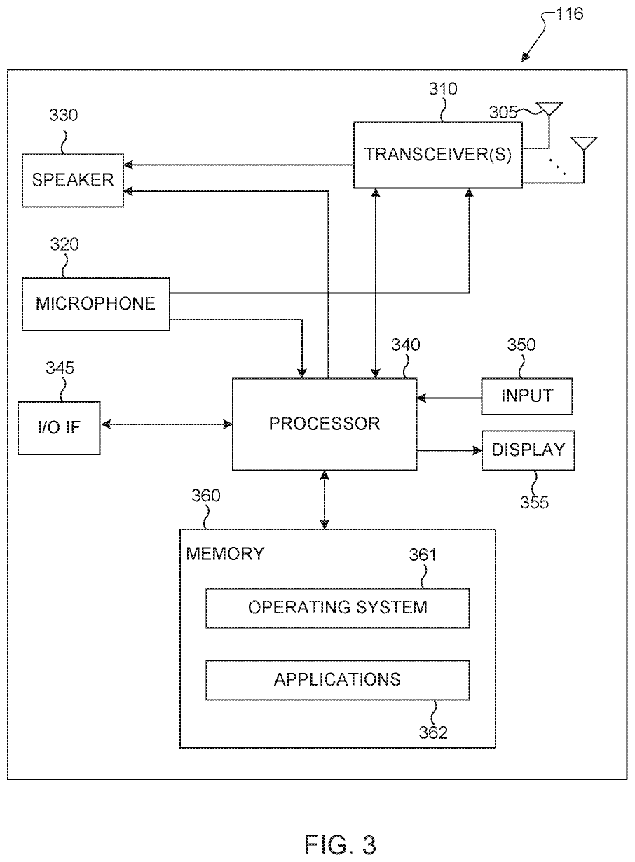

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL and/or SL channels and/or signals and the transmission of UL and/or SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a contention window adjustment on an SL in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

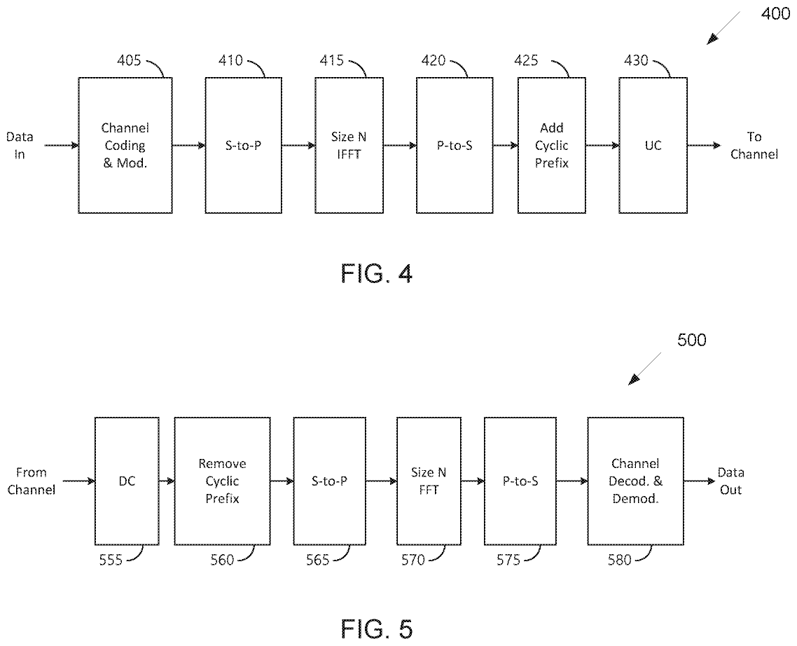

FIG. 4 and FIG. 5 illustrate example wireless transmit and receive paths according to the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. It may also be understood that the receive path 500 can be implemented in a first UE and that the transmit path 400 can be implemented in a second UE to support SL communications. In some embodiments, the receive path 500 is configured to support or enable contention window adjustment on an SL in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a downconverter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. A transmitted RF signal from a first UE arrives at a second UE after passing through the wireless channel, and reverse operations to those at the first UE are performed at the second UE.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNB s 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and/or transmitting in the sidelink to another UE and may implement the receive path 500 for receiving in the downlink from the gNBs 101-103 and/or receiving in the sidelink from another UE.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of the present disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

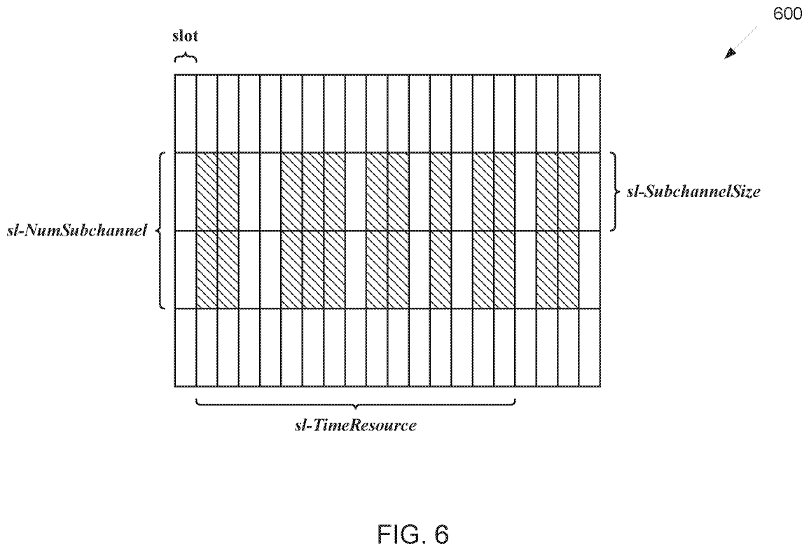

FIG. 6 illustrates an example of a resource pool in Rel-16 NR vehicle-to-everything (V2X) 600 cording to embodiments of the present disclosure. An embodiment of the resource pool in Rel-16 NR V2X 600 shown in FIG. 6 is for illustration only.

In Rel-16 NR V2X, transmission and reception of SL signals and channels are based on resource pool(s) confined in the configured SL bandwidth part (BWP). In the frequency domain, a resource pool includes a (pre-)configured number (e.g., sl-NumSubchannel) of contiguous sub-channels, wherein each sub-channel includes a set of contiguous resource blocks (RBs) in a slot with size (pre-)configured by higher layer parameter (e.g., sl-SubchannelSize). In time domain, slots in a resource pool occur with a periodicity of 10240 ms, and slots including S-SSB, non-UL slots, and reserved slots are not applicable for a resource pool. The set of slots for a resource pool is further determined within the remaining slots, based on a (pre-)configured bitmap (e.g., sl-TimeResource). An illustration of a resource pool is shown in FIG. 6.

FIG. 6 illustrates an example of a resource pool in Rel-16 NR V2X 600 according to embodiments of the present disclosure. An embodiment of the resource pool in Rel-16 NR V2X 600 shown in FIG. 6 is for illustration only.

Transmission and reception of physical sidelink shared channel (PSSCH), physical sidelink control channel (PSCCH), and physical sidelink feedback channel (PSFCH) are confined within and associated with a resource pool, with parameters (pre-)configured by higher layers (e.g., SL-PSSCH-Config, SL-PSCCH-Config, and SL-PSFCH-Config, respectively).

A UE may transmit the PSSCH in consecutive symbols within a slot of the resource pool, and PSSCH resource allocation starts from the second symbol configured for sidelink, e.g., startSLsymbol+1, and the first symbol configured for sidelink is duplicated from the second configured for sidelink, for automatic gain control (AGC) purpose. The UE may not transmit PSSCH in symbols not configured for sidelink, or in symbols configured for PSFCH, or in the last symbol configured for sidelink, or in the symbol immediately preceding the PSFCH. The frequency domain resource allocation unit for PSSCH is the sub-channel, and the sub-channel assignment is determined using the corresponding field in the associated SCI.

In Rel-16 NR-U, for operation with shared spectrum channel access (e.g., unlicensed or shared spectrum), a transmitter may perform sensing that evaluates the availability of a channel for performing transmissions. Both dynamic mode and semi-static mode channel access procedures are supported, and in the Type 1 dynamic mode channel access procedure, the sensing duration is random subject to a random counter generated between 0 and a contention window size, wherein the size of the contention window can be adjusted based on the HARQ-ACK feedback from previous transmissions.

In particular, the HARQ-ACK feedback associated with PDSCH or PUSCH in a reference duration for the latest channel occupancy are used for adjust the contention window, for DL or UL respectively, wherein the reference duration is defined as starting from the beginning of the channel occupancy until the end of the first slot where at least one unicast PDSCH is transmitted over all the resources allocated for the PDSCH or at least one PUSCH is transmitted over all the resources allocated for the PUSCH, for DL or UL respectively.

For a sidelink operated over an unlicensed spectrum, Type 1 channel access procedure with random sensing duration may also need to be supported, and the associated contention window adjustment scheme needs to be designed. This disclosure focuses on the sidelink contention window adjustment, and embodiments of this disclosure can be combined or standalone.

The present disclosure focuses on contention window adjustment for unlicensed sidelink. More precisely, the present disclosure includes the following components: (1) HARQ-ACK feedback based contention window adjustment: (i) framework of the HARQ-ACK feedback based contention window adjustment, (ii) condition for maintaining the contention window, (iii) condition for resetting the contention window, (iv) reference duration for sidelink unlicensed, and (v) HARQ-ACK feedback in sidelink unlicensed; (2) conflict information based contention window adjustment; and (3) measurement based contention window adjustment.

In one embodiment, if a UE performs a channel access procedure with random sensing duration, wherein the sensing duration is subject to a random number generated between 0 and a contention window size CW, the UE can adjust or maintain the value CW based on at least the potential HARQ-ACK feedback values.

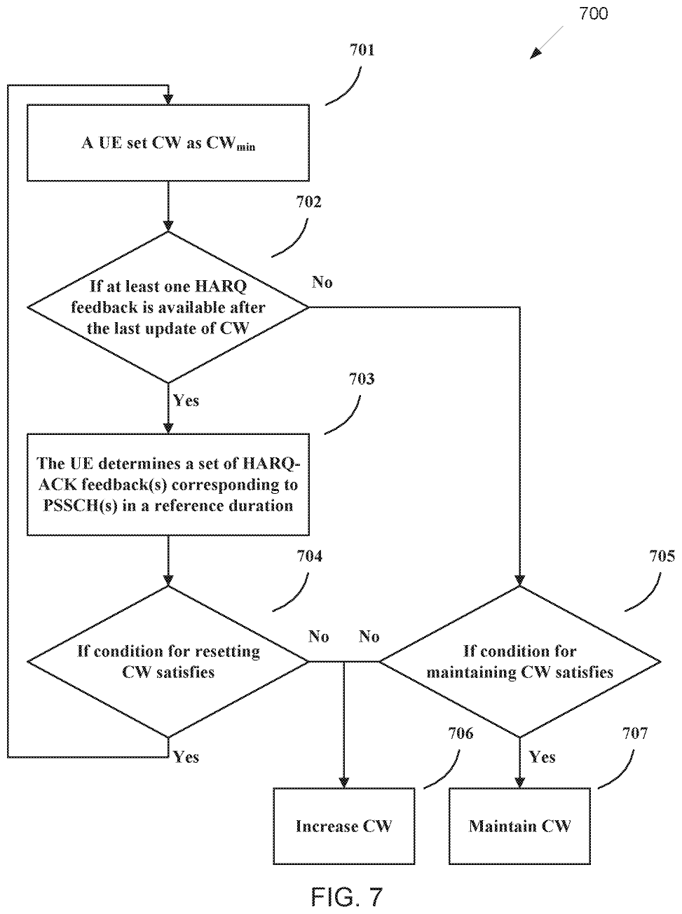

FIG. 7 illustrates a flowchart of UE method 700 for contention window adjustment according to embodiments of the present disclosure. For example, the UE method 700 as may be performed by a UE such as 111-116 as illustrated in FIG. 1. An embodiment of the UE method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

In one embodiment, the contention window is adjusted based on the battery status of the UE. In one example, if the battery status is below a threshold, contention window is adjusted to be shorter. Longer contention window may consume more battery, so shorter contention window may be preferred to conserve battery power.

As illustrated in FIG. 7, the UE method 700 begins at step 701. In step 701, the UE sets CW as CWₘᵢₙ. In step 702, the UE determines if at least one HARQ feedback is available after the last update of CW. In step 703, the UE determines a set of HARQ-ACK feedback corresponding to PSSCH(s) in a reference duration. In step 704, the UE determines If condition for resetting CW satisfies. In step 705, the UE determines if condition for maintaining CW satisfies. In step 706, the UE increases CW. In step 707, the UE maintain CW.

One example framework for performing contention window adjustment can be given by the following steps, at a timing for adjusting the contention window. An illustration of the example is shown in FIG. 7. TABLE 1 shows the step of operation.

TABLE 1
• Step 1: Set CW = CWₘᵢₙ.
• Step 2: If at least one HARQ-ACK feedback is available after the last update of CW, go
to Step 3; otherwise,

| | |
|---|---|
| ∘ | If a condition for maintaining the CW satisfies, go to Step 5, wherein the |
| | condition for maintaining the CW can be according to example of this disclosure; |
| ∘ | If a condition for maintaining the CW does not satisfy, go to Step 4, wherein the |
| | condition for maintaining the CW can be according to example of this disclosure. |

```
• Step 3: For the HARQ-ACK feedback corresponding to PSSCH(s) in a reference
  duration (e.g., corresponding to the latest sidelink channel occupancy for which HARQ-
  ACK feedback is available), wherein the reference duration can be according to example
  of this disclosure,
```

| | |
|---|---|
| ∘ | If a condition for resetting the CW satisfies, go to Step 1, wherein the condition |
| | for resetting the CW can be according to example of this disclosure; |
| ∘ | If a condition for resetting the CW does not satisfy, go to Step 4, wherein the |
| | condition for resetting the CW can be according to example of this disclosure. |

• Step 4: Increase the CW.
• Step 5: Maintain the CW.

In one example, the channel access procedure can be further associated with a channel access priority class p (e.g., p∈{1, 2, 3, 4}), and the corresponding contention window size (CWₚ) can be also associated with the channel access priority class p. The adjustment and maintenance of the value CWₚ can be jointly performed for all the channel access priority class p, and without loss of generality, the subscript in CWₚ could be omitted in this disclosure.

In another example, the adjustment and maintenance of the value CW_{c} can be performed to be associated with a cast type of the sidelink transmission (e.g., broadcast, groupcast, or unicast), and without loss of generality, the subscript in CW_{c} could be omitted in this disclosure. For instance, the adjustment and maintenance of the value CW_{c} can be performed based on the HARQ-ACK feedback information associated with the cast type c.

In yet another example, the candidate values for CW can be referred to as a set of integers with a minimum value CWₘᵢₙ and a maximum value CWₘₐₓ. For one instance, the candidate values for CW are with a form of 2ⁿ−1. For another instance, the candidate values for CW can be any integer between CWₘᵢₙ and CWₘₐₓ.

In yet another example, when the CW increases, the CW value takes a larger allowed value in the candidate values for CW. In one instance, if CW achieves CWₘₐₓ, CW maintains as CWₘₐₓ when the UE determines to increase CW. In another instance, when the UE determines to increase CW, CW can take a next larger allowed value in the candidate values for CW (e.g., until achieving CWₘₐₓ). In yet another instance, when the UE determines to increase CW, CW can take a next k-th larger allowed value in the candidate values for CW (e.g., until achieving CWₘₐₓ), wherein k is the step size on increasing CW, and the determination of k could be according to examples of this disclosure on increasing the CW.

In one embodiment, at least one of the following example condition can be used for maintaining the CW in the sidelink channel access procedure.

In one example, if the sidelink transmission(s) are not associated with HARQ-ACK feedback information, the UE can determine to maintain the CW. For one sub-example, the sidelink transmission(s) can be PSSCH transmission(s) with cast type as broadcast. For another sub-example, the sidelink transmission(s) can be PSSCH transmission(s) without HARQ-feedback enabled. For yet another sub-example, the sidelink transmission(s) can be S-SS/PSBCH block transmission(s). For yet another sub-example, the sidelink transmission(s) can be standalone sidelink RS transmission(s). For yet another sub-example, the sidelink transmission(s) can be PSSCH transmission(s) with NACK only HARQ feedback. For yet another sub-example, the sidelink transmission(s) can be combination and/or multiplexing of above sub-examples.

In another example, if the sidelink transmission(s) do not include a retransmission, the UE can determine to maintain the CW. For one sub-example, the sidelink transmission(s) can be the transmission(s) performed in the first reserved resource for its transmission. For another sub-example, the sidelink transmission(s) can be the first transmission(s) of the corresponding TB in the set of reserved resources.

In yet another example, if the sidelink transmission(s) is within a duration T_{w} from the end of the reference duration (e.g., corresponding to the earliest sidelink channel occupancy after the last update of CW), the UE can determine to maintain the CW, wherein the definition of reference duration can be according to example of this disclosure.

In one sub-example, T_{w} can be determined based on a duration T_{A}, wherein T_{A} can be fixed (e.g., T_{A}=5 ms if the absence of any other technology sharing the channel cannot be guaranteed, for instance based on an indication; or T_{A}=10 ms if the absence of any other technology sharing the channel can be guaranteed, for instance based on an indication).

In another sub-example, T_{w} can be determined based on a duration T_{B}, wherein T_{B} is the duration of the sidelink transmission burst from the start of the reference duration.

In yet another sub-example, T_{w}, can be determined based on a duration T_{C}, wherein T_{C} can be a duration determined based on the PSFCH transmission occasion. For one instance, T_{C} is the duration from the start of the reference duration to the first PSFCH transmission occasion after the start of the reference duration. For another instance, T_{C} is the duration from the end of the reference duration to the first PSFCH transmission occasion after the end of the reference duration.

In yet another sub-example, T_{w} can be determined as maximum of at least one of T_{A}, T_{B}, or T_{C}. For one instance, T_{w}=T_{A}. For another instance, T_{w}=T_{B}. For yet another instance, T_{w}=T_{C}. For yet another instance, T_{w}=max(T_{A}, T_{B}). For yet another instance, T_{w}=max(T_{A}, T_{C}). For yet another instance, T_{w}=max(T_{B}, T_{C}). For yet another instance, T_{w}=max(T_{A}, T_{B}, T_{C}).

In one example, if the HARQ-ACK feedback for sidelink transmission(s) (e.g., included in the reference duration) are not all available, the UE can determine to maintain the CW. For one instance, there can be a further condition that the received HARQ-ACK feedback for sidelink transmission(s) are all ACK, but not all the HARQ-ACK feedback for sidelink transmission(s) are available. For another instance, there can be a further condition that the received HARQ-ACK feedback for sidelink transmission(s) includes a NACK, but not all the HARQ-ACK feedback for sidelink transmission(s) are available.

In one example, if the priority of the sidelink transmission(s) is high, the UE can determine to maintain the CW. For one sub-example, if the priority value of the sidelink transmission(s) is lower than (or no higher than) a threshold, the UE can determine to maintain the CW. For one instance, the threshold can be a fixed value. For another instance, the threshold can be provided by a pre-configuration. For yet another instance, the threshold can be provided by a Uu RRC parameter. For yet another instance, the threshold can be provided by a PC5 RRC parameter.

In one example, if the UE does not receive any conflict information after the last update of CW, the UE can determine to maintain the CW.

In one example, if the measurement result is in a value range, the UE can determine to maintain the CW. For one instance, the value range can be fixed in the specification. For another instance, the value range can be determined based on parameter(s) provided by a pre-configuration. For yet another instance, the value range can be determined based on parameter(s) provided by a Uu RRC parameter. For yet another instance, the value range can be determined based on parameter(s) provided by a PC5 RRC parameter.

In one embodiment, at least one of the following example condition can be used for resetting the CW in the sidelink channel access procedure, e.g., for the case at least one HARQ-ACK feedback is available after the last update of CW.

In one example, if the at least one HARQ-ACK feedback corresponding to PSSCH(s) in a reference duration includes an ACK, CW can be reset to the minimum value CWₘᵢₙ.

In another example, if the at least one HARQ-ACK feedback corresponding to PSSCH(s) in a reference duration includes ACK(s), wherein a ratio of the ACK(s) is above (or not lower than) a threshold, CW can be reset to the minimum value CWₘᵢₙ. For one instance, the threshold can be a fixed value (e.g., 10%, or 50%, or 80%). For another instance, the threshold can be provided by a pre-configuration. For yet another instance, the threshold can be provided by a Uu RRC parameter. For yet another instance, the threshold can be provided by a PC5 RRC parameter.

In yet another example, if the at least one HARQ-ACK feedback corresponding to PSSCH(s) in a reference duration are all ACK(s), CW can be reset to the minimum value CWₘᵢₙ.

In yet another example, if the at least one HARQ-ACK feedback correspond to a groupcast PSSCH (e.g., with HARQ-ACK feedback including ACK or NACK), and the HARQ-ACK feedback corresponding to the groupcast PSSCH includes an ACK, CW can be reset to the minimum value CWₘᵢₙ.

In yet another example, if the at least one HARQ-ACK feedback correspond to a groupcast PSSCH (e.g., with HARQ-ACK feedback including ACK or NACK), and the HARQ-ACK feedback corresponding to the groupcast PSSCH includes a ratio of ACK to be at least above a threshold, CW can be reset to the minimum value CWₘᵢₙ. For one instance, the threshold can be a fixed value (e.g., 10%, or 50%, or 80%). For another instance, the threshold can be provided by a pre-configuration. For yet another instance, the threshold can be provided by a Uu RRC parameter. For yet another instance, the threshold can be provided by a PC5 RRC parameter.

In yet another example, if the at least one HARQ-ACK feedback correspond to a groupcast PSSCH (e.g., with HARQ-ACK feedback including ACK or NACK), and the HARQ-ACK feedback corresponding to the groupcast PSSCH are all ACK(s), CW can be reset to the minimum value CWₘᵢₙ.

In yet another example, if the at least one HARQ-ACK feedback correspond to a groupcast PSSCH (e.g., with HARQ-ACK feedback including only NACK), and the HARQ-ACK feedback corresponding to the groupcast PSSCH is not received (e.g., no NACK received), CW can be reset to the minimum value CWₘᵢₙ. For instance, if the HARQ-ACK feedback corresponding to the groupcast PSSCH includes a NACK, CW needs to increase.

In one embodiment, there could be one further condition combining with at least one of the above example that at least one HARQ-ACK feedback corresponding to PSSCH(s) in a reference duration may include all the HARQ-ACK feedback corresponding to PSSCH(s) in the reference duration, e.g., the UE may wait for receiving all the HARQ-ACK feedback corresponding to PSSCH(s) in the reference duration and then determines to adjust the CW, otherwise, CW increases.

In one embodiment, the supporting of the above examples can be subject to the priority value of the sidelink transmission(s). For instance, one example with lower requirement to reset the CW can be supported for sidelink transmission(s) with smaller priority value, and another example with higher requirement to reset the CW can be supported for sidelink transmission(s) with larger priority value.

In one embodiment, a reference duration can be defined for an associated sidelink channel occupancy according to at least one of the following example.

In one example, a reference duration can start from the beginning of the sidelink channel occupancy (e.g., the channel occupancy includes the at least the PSSCH transmission).

In one example, a reference duration can end at the end of the first slot, or the end of the transmission burst, or the earlier of the two timing, wherein at least one unicast PSSCH is transmitted. In a further consideration, the PSSCH can be transmitted over all the resources allocated for the PSSCH (e.g., if transmission based on partial resources allocated for the PSSCH is supported).

In one example, a reference duration can end at the end of the first slot, or the end of the transmission burst, or the earlier of the two timing, wherein at least one unicast PSSCH or groupcast PSSCH is transmitted. In a further consideration, the PSSCH can be transmitted over all the resources allocated for the PSSCH (e.g., if transmission based on partial resources allocated for the PSSCH is supported).

In one example, a reference duration can end at the end of the first slot, or the end of the transmission burst, or the earlier of the two timing, wherein at least one PSSCH (e.g., unicast PSSCH or groupcast PSSCH) with HARQ information including ACK or NACK is transmitted. In a further consideration, the PSSCH can be transmitted over all the resources allocated for the PSSCH (e.g., if transmission based on partial resources allocated for the PSSCH is supported).

In one example, a reference duration can end at the end of the first slot, or the end of the transmission burst, or the earlier of the two timing, wherein at least one PSSCH (e.g., unicast PSSCH or groupcast PSSCH) with HARQ information including only NACK is transmitted. In a further consideration, the PSSCH can be transmitted over all the resources allocated for the PSSCH (e.g., if transmission based on partial resources allocated for the PSSCH is supported).

In one embodiment, a HARQ-ACK feedback can be defined for contention window adjustment according to at least one of the following example.

In one example, a HARQ-ACK feedback can be provided to the UE explicitly carried by a PSFCH transmission.

In one example, a HARQ-ACK feedback can be provided to the UE implicitly based on the indication for a new transmission or retransmission, e.g., included in the SCI. For instance, if a new transmission is indicated, the UE determines an ACK for the corresponding PSSCH. For another instance, if a retransmission is indicated, the UE determines a NACK for the corresponding PSSCH.

In one example, if a UE did not receive a HARQ-ACK feedback, e.g., at the PSFCH transmission occasion intended to receive the HARQ-ACK feedback, the UE assumes a NACK. For one instance, this is not applicable to PSSCH transmissions as groupcast with HARQ-ACK feedback including only NACK (e.g., but applicable to PSSCH transmissions as groupcast with HARQ-ACK feedback including ACK or NACK).

In one example, if the PSSCH transmission is groupcast with HARQ-ACK feedback including only NACK, and if a UE did not receive a HARQ-ACK feedback, e.g., at the PSFCH transmission occasion intended to receive the HARQ-ACK feedback, the UE assumes an ACK.

In one embodiment, conflict information can be used for contention window adjustment.

One example framework for performing contention window adjustment can be given by the following steps, at a timing for adjusting the contention window, as shown in TABLE 2.

TABLE 2
• Step 1: Set CW = CWₘᵢₙ.
• Step 2: If at least one HARQ-ACK feedback or conflict information is available after the
last update of CW, go to Step 3; Otherwise,

| | |
|---|---|
| ∘ | If a condition for maintaining the CW satisfies, go to Step 5, wherein the |
| | condition for maintaining the CW can be according to example of this disclosure; |
| ∘ | If a condition for maintaining the CW does not satisfy, go to Step 4, wherein the |
| | condition for maintaining the CW can be according to example of this disclosure. |

```
• Step 3: For the HARQ-ACK feedback or conflict information corresponding to
  PSSCH(s) in a reference duration (e.g., corresponding to the latest sidelink channel
  occupancy for which HARQ-ACK feedback or conflict information is available),
  wherein the reference duration can be according to example of this disclosure,
```

| | |
|---|---|
| ∘ | If a condition for resetting the CW satisfies, go to Step 1, wherein the condition |
| | for resetting the CW can be according to example of this disclosure; |
| ∘ | If a condition for resetting the CW does not satisfy, go to Step 4, wherein the |
| | condition for resetting the CW can be according to example of this disclosure. |

• Step 4: Increase the CW.
• Step 5: Maintain the CW.

In one example, a UE assumes a conflict information received in a PSFCH as a NACK, and the examples of this disclosure for using HARQ-ACK feedback to adjust or maintain contention window apply for using both HARQ-ACK feedback or conflict information.

In another example, a UE assumes a conflict information received in a PSFCH as an ACK, and the examples of this disclosure for using HARQ-ACK feedback to adjust or maintain contention window apply for using both HARQ-ACK feedback or conflict information.

In yet another example, a UE uses conflict information to adjust or maintain contention window only when HARQ-ACK feedback is not available. For instance, the UE first uses example of this disclosure to determine to adjust or maintain contention window based on HARQ-ACK feedback, and if HARQ-ACK feedback is not available, then the UE uses example of this disclosure to determine to adjust or maintain contention window based on conflict information.

In yet another example, the potential association of this example with CAPC, and/or the potential association of this example with cast type, and/or the example on increasing the CW, and/or the example on the candidate values for CW as described in the disclosure can be applicable to the conflict information based contention window adjustment as well.

In one embodiment, measurement result can be used for contention window adjustment.

In one example, the measurement result can include a received signal strength indicator (RSSI) measurement. For one sub-example, the RSSI measurement can be (pre-)configured to be performed over a sub-channel in frequency domain and a set of consecutive symbols/slots in time domain. For another sub-example, the RSSI measurement can be (pre-)configured to be performed over a channel (e.g., LBT bandwidth) in frequency domain and a set of consecutive symbols/slots in time domain.

In another example, the measurement result can include a channel occupancy ratio (CR), e.g., wherein the channel occupancy ratio refers to the ratio of the number of sub-channels used for transmission before the reference timing and the number of sub-channels granted after the reference timing.

In yet another example, the measurement result can include a channel busy ratio (CBR), e.g., wherein the channel busy ratio refers to the ratio of sub-channels whose RSSI measured over a measurement window by the UE exceeds a (pre-)configured threshold.

In one example, the measurement result can be used for adjusting or maintaining the contention window according to at least one of the following sub-examples.

In one sub-example, if the measurement result is within a first value range, set CW=CWₘᵢₙ.

In another sub-example, if the measurement result is within a second value range, increase CW.

In yet another sub-example, if the measurement result is within a third value range, maintain CW.

In yet another sub-example, if the measurement is not available, set CW=CWₘᵢₙ.

In yet another sub-example, if the measurement is not available, increase CW.

In yet another sub-example, if the measurement is not available, maintain CW.

In one example, at least one of the first value range, the second value range, or the third value range can be fixed in the specification.

In another example, at least one of the first value range, the second value range, or the third value range can be determined based on parameter(s) provided by a pre-configuration.

In yet another example, at least one of the first value range, the second value range, or the third value range can be determined based on parameter(s) provided by a Uu RRC parameter.

In yet another example, at least one of the first value range, the second value range, or the third value range can be determined based on parameter(s) provided by a PC5 RRC parameter.

In yet another example, the potential association of this example with CAPC, and/or the potential association of this example with cast type, and/or the example on increasing the CW, and/or the example on the candidate values for CW as described in the disclosure can be applicable to the measurement based contention window adjustment as well.

In yet another example, the measurement based contention window adjustment can be supported with HARQ-ACK feedback and/or conflict information based contention window adjustment simultaneously.

For one instance, the UE determines to set CW=CWₘᵢₙ, if both the measurement based contention window adjustment and the HARQ-ACK feedback and/or conflict information based contention window adjustment decide to set CW=CWₘᵢₙ.

For another instance, the UE determines to set CW=CWₘᵢₙ, if at least one of the measurement based contention window adjustment or the HARQ-ACK feedback and/or conflict information based contention window adjustment decides to set CW=CWₘᵢₙ.

For yet another instance, the UE determines to increase CW, if both the measurement based contention window adjustment and the HARQ-ACK feedback and/or conflict information based contention window adjustment decide to increase CW.

For yet another instance, the UE determines to increase CW, if at least one of the measurement based contention window adjustment or the HARQ-ACK feedback and/or conflict information based contention window adjustment decides to increase CW.

For yet another instance, the UE determines to decrease CW, if both the measurement based contention window adjustment and the HARQ-ACK feedback and/or conflict information based contention window adjustment decide to decrease CW.

For yet another instance, the UE determines to decrease CW, if at least one of the measurement based contention window adjustment or the HARQ-ACK feedback and/or conflict information based contention window adjustment decides to decrease CW.

In yet another example, the measurement based contention window adjustment can be supported as supplementary to the HARQ-ACK feedback and/or conflict information based contention window adjustment. For instance, when the HARQ-ACK feedback and/or conflict information is not available, the UE can use the measurement based contention window adjustment.

Meanwhile, received signal strength indicator (RSSI) measurement on sidelink is supported, wherein the measurement is performed over a sub-channel in the frequency domain and symbols mapped for PSSCH/PSCCH in a slot (excluding the first symbol in the slot). The RSSI measurement can be utilized for calculating sidelink channel busy ratio (CBR) in a targeted slot n, wherein CBR is defined as the portion of sub-channels whose RSSI exceeds a threshold, wherein the overall number of sub-channels are from a window with slot indexes [n−a, n−1], and a is provided by sl-TimeWindowSizeCBR. The CBR can be further reported to a gNB, and the UE can use CBR to define event and determine values for parameters.

A sidelink also supports sidelink channel occupancy ratio (CR) evaluated at slot n is defined as the total number of sub-channels used for its transmissions in slots [n−a, n−1] and granted in slots [n, n+b] divided by the total number of configured sub-channels in the transmission pool over [n−a, n+b]. a and b are determined by UE implementation with a+b+1=1000 or 1000·2^{μ} slots, according to higher layer parameter sl-TimeWindowSizeCR.

In Rel-16 NR-U, for operation with shared spectrum channel access (e.g., unlicensed or shared spectrum), RSSI measurement is supported, wherein the RSSI is measured over a channel (e.g., a LBT bandwidth) in the frequency domain and a set of contiguous symbols in time domain. The measurement is further confined within a RMTC window periodically showing up in the time domain. RSSI measurement can be used for determining the channel occupancy ratio for unlicensed band, wherein the channel occupancy ratio is defined as the percentage of samples whose corresponding RSSI measurement results are above a threshold given by channelOccupancyThreshold. The RSSI measurement and channel occupancy ratio are both reported to the gNB.

For sidelink operated over an unlicensed spectrum, measurement needs to be enhanced to incorporate both sidelink measurement and unlicensed band measurement.

The present disclosure focuses on measurement aspect for sidelink operation on unlicensed spectrum. More precisely, the present disclosure includes the following components: (1) unified RSSI measurement framework for sidelink unlicensed: (i) a unified configuration to support RSSI measurement for both CBR and CO calculation purposes; (ii) separate RSSI measurement framework for CBR and CO calculation purposes for sidelink unlicensed; (iii) enhancement to RSSI measurement framework for CBR purpose; (iv) supporting RSSI measurement framework for CO purpose; and/or (v) handling the overlapped resources in the two configurations.

In one embodiment, a unified RSSI measurement framework can be supported for SL-U.

For one example, the unified RSSI measurement framework can include at least one of the following components.

In one example component, the unified RSSI measurement framework can include time domain information on the resources to perform the RSSI measurement.

For one instance, the time domain resource information can be a time domain window periodically showing up, wherein the time domain window includes a periodicity, an offset, and a duration. For one sub-instance, the duration can be represented by an absolute time duration. For another sub-instance, the duration can be represented by a combination of a number of symbols and a reference numerology of the symbol, wherein the reference numerology can be either provided by pre-configuration/configuration or same as the numerology of the sidelink BWP.

For another instance, the time domain resource information can be a time domain window that showing up once before a target time instance. For instance, the target time instance can be a slot for calculating the CBR. For another instance, the time domain window includes a duration, e.g., represented by a number of slots, wherein the number of slots can be pre-configured or configured.

For yet another instance, there can be an indication on which of above instances is used as the time domain resource information.

For one further example, the UE does not expect to perform RSSI measurement outside the time domain resource (e.g., the time domain window).

In one example component, the unified RSSI measurement frameworks can include frequency domain information on the resources to perform the RSSI measurement.

For one instance, the frequency domain information can include at least one frequency location, and the UE performs RSSI measurement over a bandwidth corresponding to at least one channel (e.g., LBT bandwidth), wherein the center frequency of the at least one channel is provided by the at least one frequency location, respectively. For one sub-instance, the number of frequency location can be determined as one.

For another instance, the frequency domain information can include at least one frequency location, and the UE performs RSSI measurement over bandwidth corresponding to at least one channel (e.g., LBT bandwidth), wherein the at least one frequency location is located within the at least one channel bandwidth, respectively. For one sub-instance, the number of frequency location can be determined as one.

For yet another instance, the frequency domain information can include at least one RB-set (e.g., if the at least one RB-set is configured), and the UE performs RSSI measurement over bandwidth corresponding to the at least one RB-set. For one sub-instance, the number of RB-set can be determined as one. For another sub-instance, the indication can be at least one index of the at least one RB-set. For yet another sub-instance, the indication can be a bitmap, and each bit corresponds to a RB-set.

For yet another instance, the frequency domain information can include at least one frequency location, and the UE performs RSSI measurement over bandwidth corresponding to a sub-channel in at least one channel (e.g., LBT bandwidth), wherein the center frequency of the at least one channel is provided by the at least one frequency location, respectively. For one sub-instance, the number of frequency location can be determined as one.

For yet another instance, the frequency domain information can include at least one frequency location, and the UE performs RSSI measurement over a bandwidth corresponding to a sub-channel in at least one channel (e.g., LBT bandwidth), wherein the at least one frequency location is located within the at least one channel bandwidth, respectively. For one sub-instance, the number of frequency location can be determined as one.

For yet another instance, the frequency domain information can include at least one RB-set (e.g., if the at least one RB-set is configured), and the UE performs RSSI measurement over a bandwidth corresponding to a sub-channel in the at least one RB-set. For one sub-instance, the number of RB-set can be determined as one. For another sub-instance, the indication can be at least one index of the at least one RB-set. For yet another sub-instance, the indication can be a bitmap, and each bit corresponds to a RB-set.

In one example component, the unified RSSI measurement framework can include at least one threshold.

For one instance, there can be one single threshold included in the RSSI measurement framework, and the UE determines CBR and/or channel occupancy based on the single threshold.

For another instance, there can be two thresholds included in the RSSI measurement framework, and the UE determines CBR using the first threshold, and determines channel occupancy using the second threshold.

In one example component, the unified RSSI measurement framework can include a measurement report.

For one instance, the measurement report for the unified RSSI measurement framework can include the RSSI measurement results related to both CBR and/or channel occupancy. For a sub-instance, the measurement report for the unified RSSI measurement framework can include the RSSI results, and/or CBR results, and/or channel occupancy results.

For another instance, the measurement report can include the RSSI measurement results related to one of CBR or channel occupancy, e.g., subject to an indication on which to report. For one sub-instance, RSSI results and/or CBR results can be included in the measurement report. For another sub-instance, RSSI results and/or channel occupancy results can be included in the measurement report.

For yet another example, the unified RSSI measurement framework can be associated with a resource pool, e.g., the configuration of the unified RSSI measurement framework can be included in the configuration for resource pool.

For yet another example, the unified RSSI measurement framework can be associated with a sidelink measurement object, e.g., the configuration of the unified RSSI measurement framework can be included in the configuration for the sidelink measurement object.

For yet another example, the unified RSSI measurement framework can be provided from a first UE to at least a second UE, e.g., by PC5 RRC.

For yet another example, the UE performs RSSI measurement in the sidelink BWP.

For yet another example, the UE can further calculate CBR based on the measurement result of the RSSI measurement.

For yet another example, the UE can further calculate channel occupancy based on the measurement result of the RSSI measurement.

For yet another example, AGC symbols (e.g., first symbol of SL symbols in the slot, and/or first symbol of PSFCH transmission) are not counted into the RS SI measurement.

For yet another example, gap symbols (e.g., gap symbol at the end of the slot, and/or gap symbol between PSSCH and PSFCH transmission) are not counted into the RSSI measurement.

In one embodiment, a UE can be provided separate configurations about RSSI measurement to calculate CBR (e.g., denoted as a first RSSI measurement configuration) and about RSSI measurement to calculate channel occupancy (e.g., denoted as a second RSSI measurement configuration) for SL-U.

In one sub-embodiment, there can be enhancements to the first RSSI measurement configuration (e.g., RSSI measurement for CBR calculation purpose) to be operated with shared spectrum channel access.

For one example, there can be an indication of at least one frequency location to be associated with the first RSSI measurement configuration, and the UE calculates the CBR based on the sub-channels within the at least one channel (e.g., LBT bandwidth), wherein the center frequency(ies) of the at least one channel are provided by the at least one frequency location, respectively. In one sub-example, there can be a single frequency location associated with the first RSSI measurement configuration, and the UE calculates the CBR based on the sub-channels within a single channel (e.g., a LBT bandwidth), wherein the center frequency of the single channel is provided by the single frequency location. In another sub-example, there can be multiple frequency locations to be associated with the first RSSI measurement configuration, and the UE calculates the CBR based on the sub-channels within the multiple channels (e.g., LBT bandwidth), wherein the center frequencies of the multiple channels are provided by the multiple frequency locations, respectively.

For another example, there can be an indication of at least one frequency location to be associated with the first RSSI measurement configuration, and the UE calculates the CBR based on the sub-channels within the at least one channel (e.g., LBT bandwidth), wherein the at least one frequency location is located within the at least one channel bandwidth, respectively. In one sub-example, there can be a single frequency location associated with the first RSSI measurement configuration, and the UE calculates the CBR based on the sub-channels within a single channel (e.g., a LBT bandwidth), wherein the single frequency location is located within the single channel bandwidth. In another sub-example, there can be multiple frequency locations to be associated with the first RSSI measurement configuration, and the UE calculates the CBR based on the sub-channels within the multiple channels (e.g., LBT bandwidth), wherein the multiple frequency locations are located within the multiple channel bandwidths, respectively.

For yet another example, there can be an indication of at least one RB-set to be associated with the first RSSI measurement configuration, and the UE calculates the CBR based on the sub-channels within the at least one RB-set (e.g., LBT bandwidth). In one sub-example, there can be a single RB-set (e.g., indicated by an index of the RB-set) associated with the first RSSI measurement configuration, and the UE calculates the CBR based on the sub-channels within the indicated single RB-set (e.g., a LBT bandwidth). In another sub-example, there can be multiple RB-sets (e.g., indicated by a bitmap of the RB-sets or a set of indexes for the RB-sets) to be associated with the first RSSI measurement configuration, and the UE calculates the CBR based on the sub-channels within the multiple RB-sets (e.g., LBT bandwidth).

For yet another example, the measurement report for the measurement according to the first RSSI measurement configuration can include the RSSI results, e.g., in addition to the CBR results.

In another sub-embodiment, there can be enhancements to support a second RSSI measurement configuration (e.g., the RSSI measurement for channel occupancy calculation purpose) on sidelink.

For one example, at least part of the second RSSI measurement configuration can be associated with a resource pool, e.g., the configuration for RSSI measurement can be included in the configuration for resource pool. For another example, at least part of the second RSSI measurement configuration can be associated with a sidelink measurement object, e.g., the configuration for RSSI measurement can be included in the configuration for sidelink measurement object.

For yet another example, at least part of the second RSSI measurement configuration can be provided by PC5 RRC.

For yet another example, at least part of the second RSSI measurement configuration can be provided by Uu RRC.

For yet another example, at least part of the second RSSI measurement configuration can be provided by pre-configuration.

For yet another example, the second RSSI measurement configuration includes a time domain window periodically showing up, wherein the time domain window includes at least one of a periodicity, an offset, and a duration. For one instance, the duration can be represented by an absolute time duration. For another instance, the duration can be represented by a combination of a number of symbols and a reference numerology of the symbol (e.g., in order to calculate an absolute time duration), wherein the reference numerology can be either provided by pre-configuration/configuration or same as the numerology of the sidelink BWP. For yet another instance, the UE only performs RSSI measurement within the window and does not perform RSSI measurement outside the window.

For yet another example, the second RSSI measurement configuration includes frequency domain information.

For one instance, the frequency domain information can include a frequency location, and the UE performs RSSI measurement over a bandwidth corresponding to a channel (e.g., LBT bandwidth), wherein the center frequency of the channel is provided by the frequency location.

For another instance, the frequency domain information can include a frequency location, and the UE performs RSSI measurement over a bandwidth corresponding to a channel (e.g., LBT bandwidth), wherein the frequency location is located within the channel bandwidth.

For yet another instance, the frequency domain information can include at least an index of the RB-set (e.g., if the RB-set is configured), and the UE performs RSSI measurement over a bandwidth corresponding to the RB-set.

For yet another example, the UE performs RSSI measurement in the sidelink BWP. For instance, if the configured frequency domain resources for RSSI measurement (e.g., channels) is outside the sidelink BWP, the UE can drop the RSSI measurement over the configured frequency domain resources (e.g., channels) outside the sidelink BWP.

For yet another example, there can be a threshold associated with the RSSI measurement, and the UE determines channel occupancy based on the threshold.

For yet another example, AGC symbols (e.g., first symbol of SL symbols in the slot, and/or first symbol of PSFCH transmission) are not counted into the RSSI measurement.

For yet another example, gap symbols (e.g., gap symbol at the end of the slot, and/or gap symbol between PSSCH and PSFCH transmission) are not counted into the RSSI measurement.

In one embodiment, there can be an indication on which of the first and second RSSI measurement configurations is enabled.

In one instance, there can be an indication to indicate either one of the two configurations is enabled.

In another instance, there can be an indication on which configuration(s) are enabled (e.g., using a bitmap or a set of bits, and each bit corresponds to a configuration).

In yet another instance, the existence of the configuration can be an implicit indication of enabling the corresponding RSSI measurement configuration.

In another embodiment, when a UE is provided with the two RSSI measurement configurations at the same time (e.g., both configurations enabled), the UE can assume the time domain and/or frequency domain of the resources for RSSI measurement according to the two RSSI measurement configurations, respectively, do not overlap.

In yet another further consideration of this embodiment, when a UE is provided with the two RSSI measurement configurations at the same time (e.g., both configurations enabled), and the time domain and/or frequency domain of the resources for RSSI measurement according to the two RSSI measurement configurations, respectively, overlap, the UE drops the RSSI measurement on the overlapped resource.

In yet another embodiment, when a UE is provided with the two RSSI measurement configurations at the same time (e.g., both configurations enabled), and the time domain and/or frequency domain of the resources for RSSI measurement according to the two RSSI measurement configurations, respectively, overlap, the UE prioritizes the RSSI measurement according to the first RSSI measurement configuration and drops the RSSI measurement according to the second RSSI measurement configuration.

In yet another embodiment, when a UE is provided with the two RSSI measurement configurations at the same time (e.g., both configurations enabled), and the time domain and/or frequency domain of the resources for RSSI measurement according to the two RSSI measurement configurations, respectively, overlap, the UE prioritizes the RSSI measurement according to the second RSSI measurement configuration and drops the RSSI measurement according to the first RSSI measurement configuration.

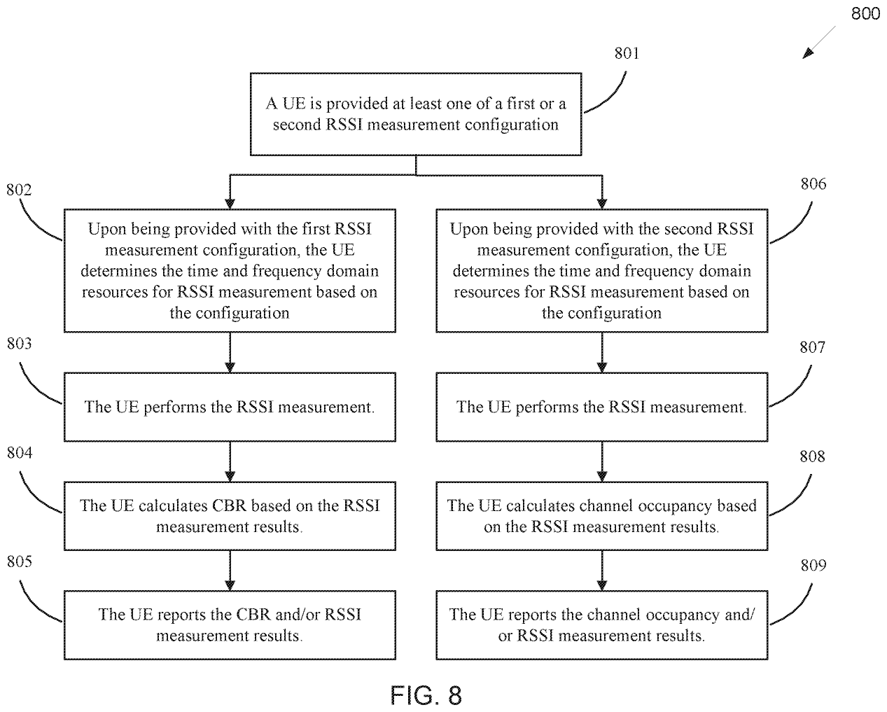

FIG. 8 illustrates a flowchart of UE method 800 for RSSI measurement for SL-U according to embodiments of the present disclosure. For example, the UE method 800 as may be performed by a UE such as 111-116 as illustrated in FIG. 1. An embodiment of the UE method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, the UE method 800 begins at step 801. In step 801, the UE is provided at least one of a first or a second RSSI measurement configuration. In step 802, upon being provided with the first RSSI measurement configuration, the UE determines the time and frequency domain resources for RSSI measurement based on the configuration. In step 803, the UE performs the RSSI measurement. In step 804, the UE calculates CBR based on the RSSI measurement results. In step 805, the UE reports the CBR and/or RSSI measurement results. In step 806, upon being provided with the second RSSI measurement configuration, the UE determines the time and frequency domain resources for RSSI measurement based on the configuration. In step 807, the UE performs the RSSI measurement. In step 808, the UE calculates channel occupancy based on the RSSI measurement results. In step 809, the UE reports the channel occupancy and/or RSSI measurement results.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to:
determine whether at least one hybrid automatic repeat request (HARQ) feedback is available after a last update of a contention window size (CW);
determine a set of HARQ feedback corresponding to physical sidelink shared channels (PSSCHs) in a reference duration, when the at least one HARQ feedback is determined as available after the last update of the CW;
determine a first condition based on the set of HARQ feedback;
determine to:
reset the CW to a minimum allowed value (CWₘᵢₙ) from a set of values, when the first condition is satisfied, or
increase the CW to a next higher allowed value from the set of values, when the first condition is not satisfied; and
perform a sidelink (SL) channel access procedure based on the CW; and
a transceiver operably coupled to the processor, the transceiver configured to perform a SL transmission over a channel, after successfully performing the SL channel access procedure.

2. The UE of claim 1, wherein the set of HARQ feedback includes acknowledgement (ACK) or negative-acknowledgment (NACK).

3. The UE of claim 1, wherein the reference duration is associated with a latest SL channel occupancy with the at least one HARQ feedback determined as available.

4. The UE of claim 1, wherein the reference duration starts from a beginning of a channel occupancy.

5. The UE of claim 1, wherein the reference duration ends at an end of a first slot that includes a transmission of at least one PSSCH with HARQ feedback enabled.

6. The UE of claim 1, wherein when CW equals a maximum allowed value (CWₘₐₓ) from the set of values, the next higher allowed value from the set of values is CWₘₐₓ.

7. The UE of claim 1, wherein the first condition includes whether at least one acknowledgement (ACK) is in the set of HARQ feedback.

8. The UE of claim 1, wherein the processor is further configured to determine whether a second condition is satisfied, when the at least one HARQ feedback is not available after the last update of the CW.

9. The UE of claim 8, wherein the processor is further configured to:
maintain the CW, when the second condition is satisfied, or
increase the CW to a next higher allowed value from the set of values, when the second condition is not satisfied.

10. The UE of claim 8, wherein the second condition includes whether:
the SL transmission is a broadcast transmission,
the SL transmission is a unicast or group cast PSSCH transmission without HARQ feedback enabled,
the SL transmission does not include a retransmission, or
the SL transmission is within a duration from an end of the reference duration.

11. A method of a user equipment (UE) in a wireless communication system, the method comprising:
determining whether at least one hybrid automatic repeat request (HARQ) feedback is available after a last update of a contention window size (CW);
determining a set of HARQ feedback corresponding to physical sidelink shared channels (PSSCHs) in a reference duration, when the at least one HARQ feedback is determined as available after the last update of the CW;
determining a first condition based on the set of HARQ feedback;
determining to:
reset the CW to a minimum allowed value (CWₘᵢₙ) from a set of values, when the first condition is satisfied, or
increase the CW to a next higher allowed value from the set of values, when the first condition is not satisfied;
performing a sidelink (SL) channel access procedure based on the CW; and
performing a SL transmission over a channel, after successfully performing the SL channel access procedure.

12. The method of claim 11, wherein the set of HARQ feedback includes acknowledgement (ACK) or negative-acknowledgment (NACK).

13. The method of claim 11, wherein the reference duration is associated with a latest SL channel occupancy with the at least one HARQ feedback determined as available.

14. The method of claim 11, wherein the reference duration starts from a beginning of a channel occupancy.

15. The method of claim 11, wherein the reference duration ends at an end of a first slot that includes a transmission of at least one PSSCH with HARQ feedback enabled.

16. The method of claim 11, wherein when CW equals to a maximum allowed value (CWₘₐₓ) from the set of values, the next higher allowed value from the set of values is CWₘₐₓ.

17. The method of claim 11, wherein the first condition includes whether at least one acknowledgement (ACK) is in the set of HARQ feedback.

18. The method of claim 11, further comprising determining whether a second condition is satisfied, when the at least one HARQ feedback is not available after the last update of the CW.

19. The method of claim 18, further comprising:
maintaining the CW, when the second condition is satisfied, or
increasing the CW to a next higher allowed value from the set of values, when the second condition is not satisfied.

20. The method of claim 18, wherein the second condition includes whether:
the SL transmission is a broadcast transmission,
the SL transmission is a unicast or group cast PSSCH transmission without HARQ feedback enabled,
the SL transmission does not include a retransmission, or
the SL transmission is within a duration from an end of the reference duration.
